(19) United States
(12) Patent Application Publication
(10) Pub. No.: US 2012/0150416 A1
(43) Pub. Date: Jun. 14, 2012

(54) Air-fuel ratio control system

(75) Inventor: Tsutomu Murakami, Kanagawa-ken (JP)

(73) Assignee: NIKKI CO., LTD., Atsugi-shi (JP)

(21) Appl. No.: 13/137,017

(22) Filed: Jul. 15, 2011

(30) Foreign Application Priority Data
Jul. 20, 2010 (JP) 2010-163093

(51) Int. Cl. F02D 41/26; F02D 41/30

(52) U.S. Cl. 701/104

(57) ABSTRACT

Even if the engine structure is not capable of continuous operation in the vicinity of stoichiometric air-fuel ratio, this engine is in the stoichiometric combustion region when condition such as low load and stable engine rotation is met, and the feedback control using the O2 sensor, although temporary, becomes possible. Therefore, the air-fuel ratio control system performs this feedback, and derives and sets the constant value for correction to attain the air-fuel ratio suited to the engine. Thereafter, the optimal air-fuel ratio is controlled at the normal control mode just by correcting the fuel injection quantity using the constant value.

### BACKGROUND OF THE INVENTION

1. Field of the Invention

The present invention relates to an air-fuel ratio control system of an engine, and more particularly to the air-fuel ratio control system for performing fuel supply at an optimal air-fuel ratio by using a detection signal of an O2 sensor.

2. Description of the Related Art

Commonly, the air-fuel ratio control system performs the fuel supply to the engine at the optimal air-fuel ratio while performing the feedback control. For example, the air-fuel ratio control system 10B discussed in Japanese Patent Publication No. 1-40213 is arranged at an air-fuel ratio control system of the engine 1B illustrated in FIG. 1 having the common hardware configuration as the present invention which will be described later.

Typically, this air-fuel ratio control system monitors exhaust gas O2 concentration from the O2 sensor 12 located on the exhaust gas passage 3, calculates a fuel injection quantity for attaining the optimal air-fuel ratio in response to an intake air quantity, and controls operation of a fuel injection nozzle 6.

However, there are some engines that cannot perform continuous operation in a vicinity of stoichiometric air-fuel ratio due to their structures. In such cases, the feedback control using the O2 sensor 12 as described previously cannot be executed. Under such circumstance, the feedback control may be performed based on an actual intake air quantity monitored by using an A/F sensor. However, in most cases, the A/F sensor being a relatively expensive component cannot be employed because of the cost.

### [Patent Document 1] Japanese Patent Publication No. 1-40213.

### SUMMARY OF THE INVENTION

The present invention attempts to solve the above-mentioned problems. The purpose of the present invention is in controlling, at low cost, the optimal air-fuel ratio, for the engines not capable of continuous operation in the vicinity of stoichiometric air-fuel ratio.

The present invention is directed to the air-fuel ratio control system for controlling the air-fuel ratio of the fuel supplied to the engine having the structure not capable of continuous operation in the vicinity of stoichiometric air-fuel ratio. The air-fuel ratio control system can monitor the exhaust gas O2 concentration based on the detection signal output from the O2 sensor disposed on the exhaust gas passage. The air-fuel ratio control system also monitors a predefined operating condition of the engine in the stoichiometric combustion region. The air-fuel ratio control system, temporarily executes a stoichiometric feedback control based on the exhaust gas O2 concentration, after warming up of the engine is finished and when the operating condition of the engine in the stoichiometric combustion region is monitored, derives and sets a constant value for correcting the fuel supply quantity to attain the air-fuel ratio suited to the engine based on the control data, shifts to the normal air-fuel ratio control mode that does not use the exhaust gas O2 concentration, and controls the air-fuel ratio while correcting the fuel supply quantity based on the set constant value.

Even if the engine structure is not capable of continuous operation in the vicinity of stoichiometric air-fuel ratio, this engine is in the stoichiometric combustion region when condition such as low load and stable engine rotation is met, and the feedback control using the O2 sensor, although temporary, becomes possible. Therefore, the air-fuel ratio control system performs this feedback, and derives and sets the constant value for correction to attain the air-fuel ratio suited to the engine. Thereafter, the optimal air-fuel ratio is controlled at the normal control mode just by correcting the fuel injection quantity using the constant value.

Moreover, this air-fuel ratio control system may detect a predefined engine condition that may lead to an engine failure during execution of the stoichiometric feedback control. The air-fuel ratio control system avoids the engine failure resulting from abnormal increase in the engine temperature due to high load put on the engine by shifting to the normal air-fuel ratio control mode.

Furthermore, the air-fuel ratio control system, during the operating condition of the engine in the stoichiometric operation region, is characteristically made to at least include the following conditions: the condition of stably fluctuating engine rpm within the predefined range; and the condition of low engine load below the predefined level. In this way, the air-fuel ratio control system, without having to enlarge processing load of the air-fuel ratio control system, can appropriately determine whether or not to execute the stoichiometric feedback control.

According to the present invention, the air-fuel ratio control system derives and sets the constant value to attain the air-fuel ratio suited to the engine by temporarily performing the stoichiometric feedback control using the exhaust gas O2 concentration, and uses the constant value in correcting the fuel supply quantity at the control mode that does not use the exhaust gas O2 concentration. The present invention can perform, at low cost, the appropriate air-fuel ratio control, in regard to the engine not capable of the continuous operation in the vicinity of stoichiometric air-fuel ratio.

### BRIEF DESCRIPTION OF THE DRAWINGS

FIG. 1 is a diagrammatic view illustrating an air-fuel ratio control system provided with the air-fuel ratio control system of the embodiments of the present invention or the conventional air-fuel ratio control system; and

FIG. 2 is a flowchart illustrating detailed contents of control carried out by the air-fuel ratio control system according to the present invention.

### DESCRIPTION OF THE PREFERRED EMBODIMENTS

Hereinafter, best modes for carrying out the invention will be described with reference to the accompanying drawings.

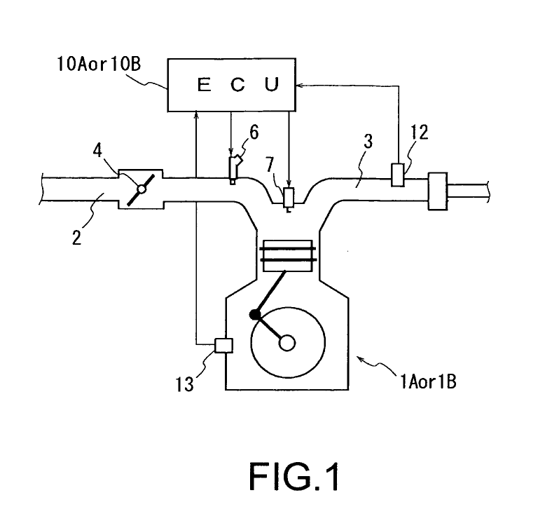

FIG. 1 illustrates the diagrammatic view of the air-fuel ratio control system of an engine 1A provided with the air-fuel ratio control system 10A of the present embodiments. The air-fuel ratio control system shares the common hardware configuration as the aforementioned conventional art. Referring to FIG. 1, a throttle valve 4 and the fuel injection nozzle 6 are disposed on an intake air passage 2. An ignition plug 7 and an engine rpm sensor 13 are disposed on the engine 1A. The O2 sensor 12 is disposed on the exhaust gas passage 3.

This air-fuel ratio control system 10A controls the air-fuel ratio of the supply fuel by opening of the throttle valve 4 (or, accelerator position), and by opening and closing the fuel injection nozzle 6 while detecting an operation condition of the throttle valve 4 and an engine operating condition, based on data such as the engine rpm and the exhaust gas O2 concentration. This point is the same as the conventional air-fuel ratio control system 10B described previously.

However, the engine 1A is structurally different from the previously described engine 1B. With the structure of the engine 1A, the engine 1A cannot perform the continuous operation in the vicinity of stoichiometric air-fuel ratio and cannot perform the stoichiometric feedback air-fuel ratio control based on the previously described exhaust gas O2 concentration. For these reasons, the air-fuel ratio control of the engine 1A of this air-fuel ratio control system 10A employs an alternative method different from the conventional art. This point is the characteristic part of the present invention.

In other words, the engine 1A, being structurally not capable of continuous operation in the vicinity of stoichiometric air-fuel ratio, cannot perform the stoichiometric feedback control using the O2 sensor 12. However, in spite of being the engine not capable of continuous operation in the vicinity of stoichiometric air-fuel ratio, an operating condition of the engine 1A in stoichiometric combustion region is known to exist temporarily.

Hence, after the warming up of the engine is finished, the operating condition of the engine 1A in stoichiometric combustion region meets the predefined conditions, such as the low engine load below the predefined level and the engine rotation stabilized within the predefined range. In the condition is met, the air-fuel ratio control system 10A that detected these conditions temporarily performs the stoichiometric feedback air-fuel ratio control using the exhaust gas O2 concentration measured from the O2 sensor during these conditions, derives and sets the constant value for correcting the fuel injection quantity using the predefined method based on these control data, shifts to the normal air-fuel ratio control mode not using the exhaust gas O2 concentration thereafter, and corrects the fuel injection quantity by using the constant value to achieve the air-fuel ratio suited for the engine 1A.

Furthermore, various conditions, serving as the operating conditions of the engine in the stoichiometric combustion region, such as the low engine load below the predefined level and the engine rotation stabilized within the predefined range, can be obtained from a trial experiment of the engine 1A beforehand. The specific conditions are set on the basis of experimental results.

Moreover, as the engine 1A has the structure that is not capable of continuous operation in the vicinity of stoichiometric air-fuel ratio, threrefore, when the load is put on the engine or when the engine temperature increases abnormally during the stoichiometric feedback control mode, these may cause the failure of engine 1A. Therefore, when the air-fuel ratio control system 10A has detected such abnormal conditions, the risk of engine failure is avoided by setting the engine 1A to promptly shift to the normal control mode that does not depend on the stoichiometric feedback control using the exhaust gas O2 concentration.

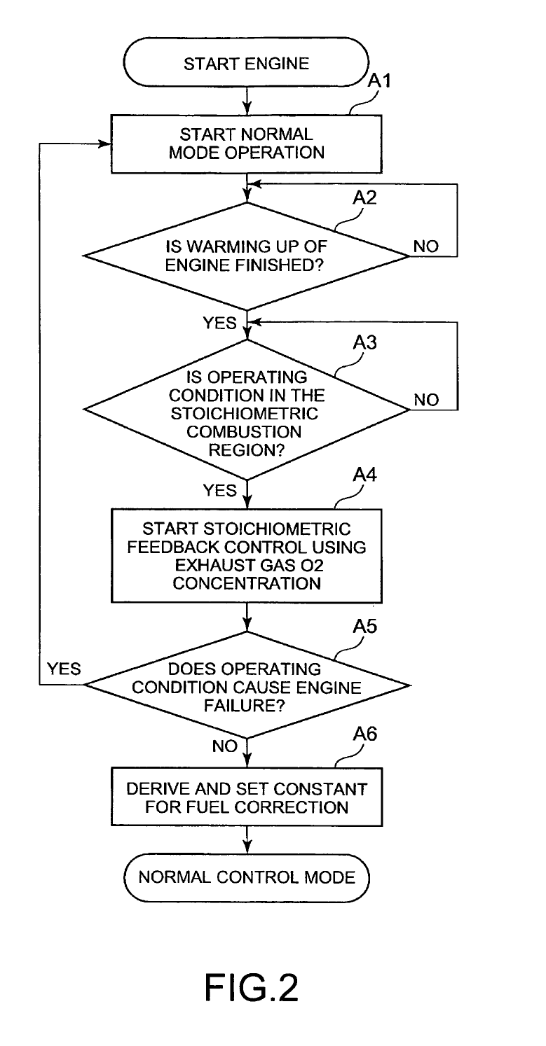

FIG. 2 illustrates a flowchart for describing the detailed contents of control for the air-fuel ratio control system 10A of the embodiments. After ignition of the engine 1A, initially, a program starts a control at the normal mode that does not depend on the stoichiometric feedback control using the exhaust gas O2 concentration (process A1). After that, the program determines whether or not the warming up is finished (process A2). If the warming up is finished, the program determines whether or not the previously described operating condition of the engine in the stoichiometric combustion region is met (process A3). If the operating condition of the engine in the stoichiometric combustion region is not met, the program returns to the previous process to repeat the determination.

However, if the operating condition of the engine in the stoichiometric combustion region is met, the program executes the stoichiometric feedback air-fuel ratio control based on the exhaust O2 concentration (process A4). Based on this control data, the program derives and sets the constant value for correcting the fuel injection quantity (process A6). After returning to the normal control mode, the program performs the air-fuel ratio control that does not depend on the stoichiometric air-fuel ratio by using the constant value. On the other hand, if the program detects the predefined operation condition that may invite engine failure during the stoichiometric feedback control mode (process A5), the program promptly returns to the normal control mode to avoid the engine failure.

Accordingly, regardless of the engine 1A having the structure of not capable of continuous operation in the vicinity of stoichiometric air-fuel ratio, the control of the air-fuel ratio is appropriately performed without relying on the stoichiometric feedback control using the exhaust gas O2 concentration. The present invention is implemented by temporarily performing the feedback control based on the exhaust gas O2 concentration, and setting the constant value for correcting the fuel supply quantity to attain the appropriate air-fuel ratio depending on the characteristics of the engine 1A. For this reason, the present invention can be implemented just by modifying the contents of the control (control software) of the conventional air-fuel ratio control system 10B, without having to add an expensive component. The cost is reduced effectively.

As described above, the present invention allows the engine not capable of continuous operation in the vicinity of stoichiometric air-fuel ratio to perform, at low cost, the appropriate air-fuel rate control by using the O2 sensor.

What is claimed is:

1. An air-fuel ratio control system for controlling a air-fuel ratio of fuel supplied to an engine having the structure not capable of continuous operation in a vicinity of stoichiometric air-fuel ratio, comprising:
a control unit that monitors exhaust gas O2 concentration based on a detection signal output from an O2 sensor disposed on an exhaust gas passage, and that monitors a predefined operating condition of the engine in the stoichiometric combustion region, temporarily executes a stoichiometric feedback control based on the exhaust gas O2 concentration after warming up of the engine is finished and when the operating condition in the stoichiometric combustion region is monitored, derives and sets a constant value for correcting a fuel supply quantity to attain the air-fuel ratio suited to the engine based on the control data, shifts to the normal air-fuel ratio control mode that does not use the exhaust gas O2 concentration, and controls the air-fuel ratio while correcting a fuel supply quantity based on the set constant value.

2. The air-fuel ratio control system according to claim 1, wherein the control unit shifts to the normal air-fuel ratio control mode, in case of detecting a predefined operating condition of the engine that may lead to engine failure during the feedback control.

3. The air-fuel ratio control system according to claim 1, wherein the operating condition in the stoichiometric combustion region at least include the following conditions:
a condition of stably fluctuating engine rpm within the predefined range; and a condition of low engine load below the predefined level.

4. The air-fuel ratio control system according to claim 2, wherein the operating condition in the stoichiometric combustion region at least include the following conditions:
a condition of stably fluctuating engine rpm within the predefined range; and a condition of low engine load below the predefined level.
